(19) United States
(12) Patent Application Publication
(10) Pub. No.: US 2007/0103583 A1
(43) Pub. Date: May 10, 2007

(54) DISPLAY WALL COMPRISING MULTIPLE DISPLAYS AND METHOD OF OPERATION THEREOF

(76) Inventors: William Robert Burnett, Menlo Park, CA (US); Charles Chia-ming Chuang, Shanghai (CN); Qing Guo, Shanghai (CN)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/550,407

(22) Filed: Oct. 18, 2006

Related U.S. Application Data
(60) Provisional application No. 60/728,917, filed on Oct. 21, 2005.

(51) Int. Cl. H04N 9/12

(52) U.S. Cl. 348/383

(57) ABSTRACT

The display wall comprises a plurality of display modules, each have a screen held in place with a plurality of pins at the screen's perimeter. A processor adjusts border brightness such that adjacent border areas of adjacent screens match brightness within about 5% of each other.

### PRIORITY REFERENCE TO PRIOR APPLICATIONS

This application claims benefit of and incorporates by reference U.S. patent application Ser. No. 60/728,917, entitled “Method for Alignment of Multiple Rear Projection Displays for Display Wall Application,” filed on Oct. 21, 2005, by inventor William Burnett.

### TECHNICAL FIELD

This invention relates generally to displays, and more particularly, but not exclusively, provides a display wall comprising multiple displays and a method of operation thereof.

### BACKGROUND

A display wall (e.g., a wall of tiled displays) is an excellent construction method for applications that requires high resolution and large display area because the resolution and the display area can be partitioned into cost effective smaller display modules. A display wall is also an excellent method for handling multiple, high resolution video inputs since they can be partitioned and handled separately by different display modules or a group of display modules. Further, there is no requirement for a high power central processor to handle and process very high resolution video data streams.

However, a display wall usually has gaps in between displays if displays are made out of liquid crystal displays (LCDs), Plasma or cathode ray tubes (CRTs). By their construction, it is very hard to eliminate display bezel or borders. LCD and Plasma technology have driver electronics beyond the active display area that forms a non-display border. A CRT requires an evacuated vacuum to work and the glass envelope also forms a non-display border.

Currently, only projection technology offers a solution where a mullion (gap between displays) can be minimized to 1.0 mm or less. Most projection light source include a single lamp that approximates a point source, so the color temperature across a single display is very uniform, much better than LCD or Plasma. The projection optics, however, exhibits fairly large brightness differences from the center of a display to its borders. Commercial products typically have 20% to 25% brightness fall off as a marketing specification. Along the display border of a singular display, the brightness fall off is subject to projection optical design limitations and component tolerances and the brightness can be different from one region (e.g. comer) to another region (e.g. the center of one side). While the brightness non-uniformity for a singular display is accepted in the marketplace, when displays are tiled together, display brightness differences between two adjacent displays can become accented and conspicuous.

The human visual system is more sensitive to rapid changes within a small visual angle to the same changes across a wider visual angle. Average brightness across displays can be different by as much as 10-20%. If the border across displays varies by more than 5%, the discontinuity can be discerned.

Conventionally, along the border between two displays, the brightness variation can be very different from display to display, as much as 20%. Along the border between displays, the brightness discontinuity can therefore be picked out easily by the human visual system. The key to minimize the brightness discontinuity across displays within a video wall is to match the brightness at display borders to within 5%, and the average brightness across displays to within 10-20%

Current methods for display wall geometry and color alignment are manual or semiautomatic, time consuming to install and readjust. The alignment difficulties increases total system cost and slowed their adoption.

One solution to the deficiencies mentioned above is to have multiple projectors with overlapping borders. However, overlapping display borders requires one contiguous large screen that is difficult to transport. Mechanical structures for modular screens also interfere with the overlapping requirement.

Accordingly, a new display wall and method of operation are required to overcome the above deficiencies.

### SUMMARY

Embodiments of the present invention overcome the above-mentioned deficiencies by adjusting border brightness and brightness uniformity in each light engine of each display module of a display wall. In addition, each screen of each module is held in place via pins that are outside the light path of the light engines, thereby minimizing the mullion.

In an embodiment, a display wall comprises a plurality of display modules and a fixture having ribs and pins. Each module has a screen and a light engine capable of projecting an image onto a screen of the module. The pins hold the plurality of screens in place via the screens' perimeters.

In an embodiment, a display wall comprises a plurality of display modules; a camera, and a processor. Each module has a screen and a light engine that projects an image onto the screen. The camera images a screen of a display module and at least a portion of a screen of an adjacent module. The processor, which is communicatively coupled to the camera and at least one light engine, adjusts brightness of the at least one light engine such that a projected image from the at least one engine matches brightness of the at least a portion of a screen of an adjacent module within about 5%.

In an embodiment, a method of adjust brightness comprises: displaying images on screens of the display wall; imaging the screens; determining brightness of border areas of the screens; and matching brightness of border areas in a screen to within about 5% of border areas of an adjacent screen.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A and FIG. 1B are diagrams illustrating a top and rear view of a display wall according to an embodiment of the invention;

FIG. 2 is a diagram illustrating a perspective view of the display wall of FIG. 1;

FIG. 3 is a diagram illustrating a fixture of the display wall;

FIG. 4 is a diagram illustrating a field of view of a camera of the display wall;

FIG. 5 is a diagram illustrating fields of views from multiple cameras of the display wall;

FIG. 6 is a flowchart illustrating a method of adjusting brightness of the display wall;

FIG. 7 is a block diagram illustrating a circuit for adjusting brightness of the display wall;

FIG. 8 is a diagram illustrating a display wall according to another embodiment of the invention;

FIG. 9 is a diagram illustrating a field of view of a camera of the display wall of FIG. 8;

FIG. 10 is a block diagram illustrating a circuit for adjusting brightness of the display wall of FIG. 8;

FIG. 11 is a block diagram illustrating a display wall according to another embodiment of the invention;

FIG. 12 is a block diagram illustrating a circuit for adjusting brightness of the display wall of FIG. 11; and

FIG. 13A and FIG. 13B are graphs showing brightness variation before and after adjustment.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

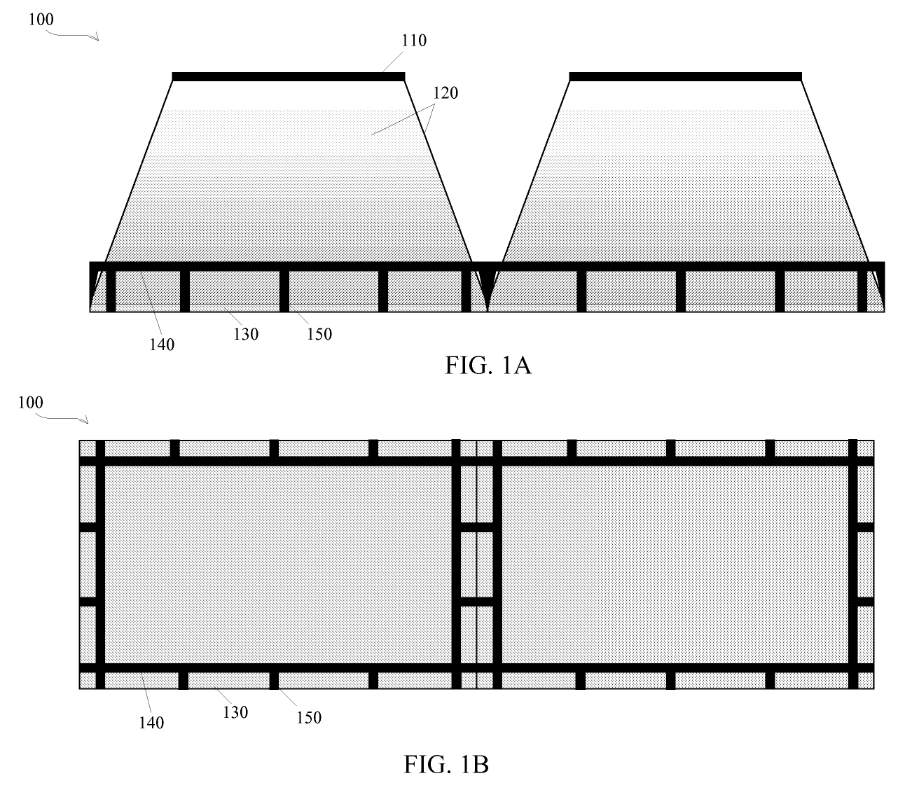

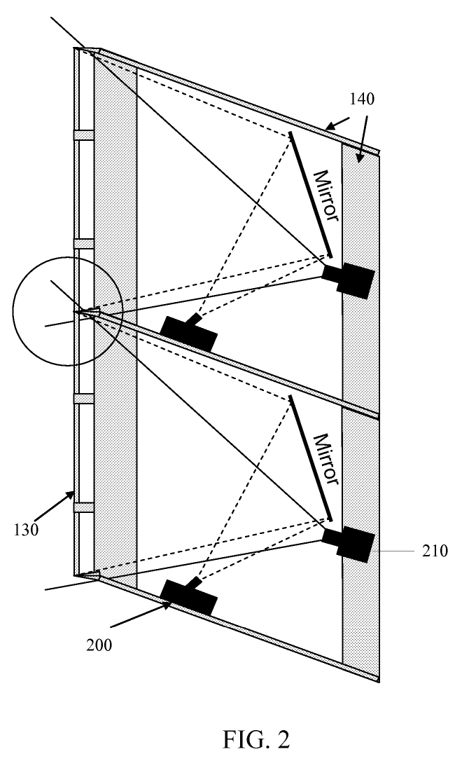

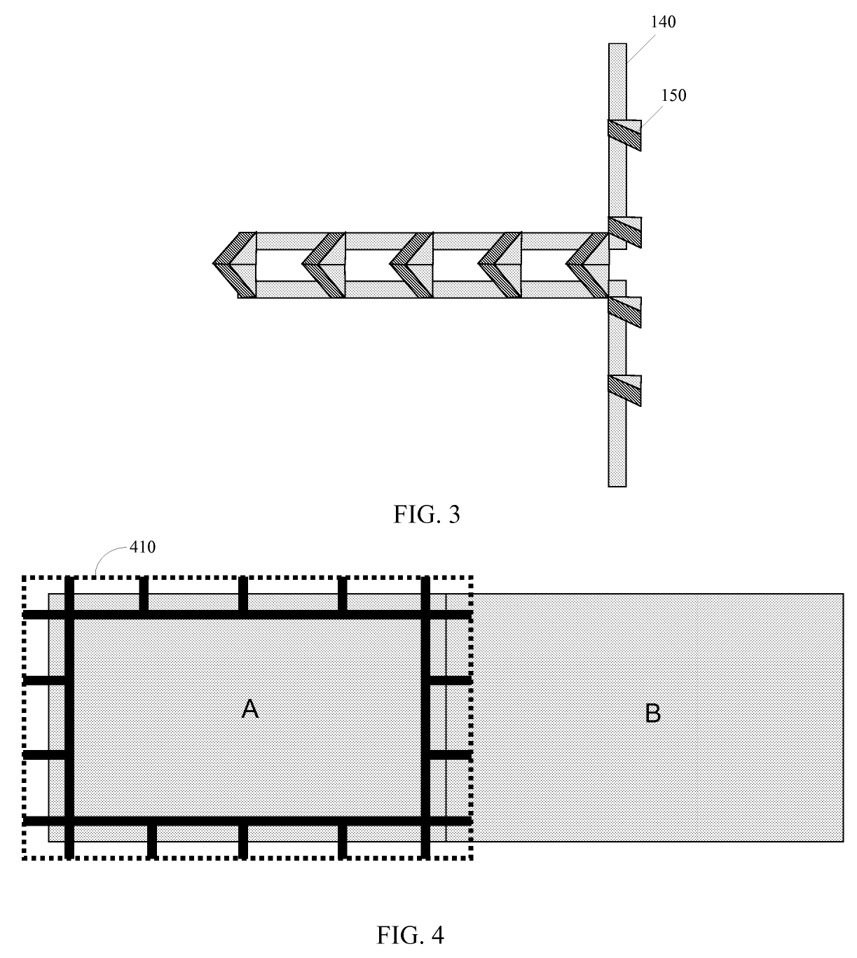

FIG. 1A and FIG. 1B are diagrams illustrating a top and rear view of a display wall 100 according to an embodiment of the invention. The display wall 100 comprises a plurality (e.g., 4) of displays linked together via a fixture 140 comprising ribs and pins 150, as will be discussed in further detail in conjunction with FIG. 3 below. Each display includes a mirror 110 that reflects an image from a light engine 200 (FIG. 2) onto a screen 130. The optical projection paths are shown by the solid lines 120. As such, the fixture 140 is outside of the projection path, as will be discussed in further detail below.

FIG. 2 is a diagram illustrating a perspective view of the display wall 100. The light engine 200 projects an image on to a mirror, which reflects the image onto the screen 130. Multiple screens are linked together via the fixture 140. In addition, a camera mounted to the fixture 140 images the screen 130 for each display in the display wall 100. The screen 130 will reflect sufficient light back toward the camera 210 for the system to discern brightness and geometry features. The field of view extends beyond one projection display module so the neighboring display's borders are visible. There are gaps in between mechanical attachment fixtures so the camera can capture most of the borders. Since the border area of multiple displays is visible in one camera, a feedback control system coupled to the camera 210 and light engine 200 bring the brightness uniformity of adjacent display borders to within 5%. The screen brightness changes gradually from the brightest spot on screen to the dimmest spot on screen.

FIG. 3 is a diagram illustrating a fixture 140 of the display wall. The fixture 140 comprises a plurality of ribs and pins 150. In an embodiment, the pins 150 are conical, triangular, or pyramidal in shape such that a tip (e.g., head) of the pin 150 holds in place the screen 130, thereby minimizing the mullion between displays while not blocking the projection of an image. The pins 150 hold the screen 130 in place by its perimeter, thereby minimizing the mullion.

The pins 150 that are visible to the camera 210 have, in one embodiment, a feature or features embedded on their surfaces for identification. These can be, but are not limited to, fiducial markings, bar code markings, three dimensional bar code markings, holographic markings, or other types of markings that can contain information that the camera or sensors can decode. This information might contain, but is not limited to, the serial number of the display, the calibration between the pin and the projected image for each individual display, and other information that might make alignment easier.

In an embodiment, the fixture 140 includes 2 pins and 2 reference holes per side, for multiple unit precision stacking. Pin and hold technique includes tab/slot, tapered pin/taped hole, 2 slots and a biscuit. Alignment features are placed in a region that is visible to the camera 210 in the adjacent display (e.g., see viewing area 410 of FIG. 4) but not in the light path of that display's projection system.

As such, as disclosed in U.S. patent application Ser. No. 11/164,814, entitled “Image Adaptation System and Method,” which is hereby incorporated by reference, a vision system can be used in the alignment of the projection display module so the display geometry of each module can be controlled to within a fraction of a display pixel. With this embodiment, optical path design that projects the image all the way to the edges of the display surface within a fraction of a display pixel can be implemented. The modules forming the display wall 100 can be aligned using the camera 210 during manufacture, and/or during installation, and/or after installation (e.g., when powering on each day or at other intervals).

FIG. 5 is a diagram illustrating fields of views from multiple cameras of the display wall 100. Each camera 210 has a field of view that extends slightly outwards from the screen 130 (e.g., about 5% of the area covered by a field of view includes an adjoining screen).

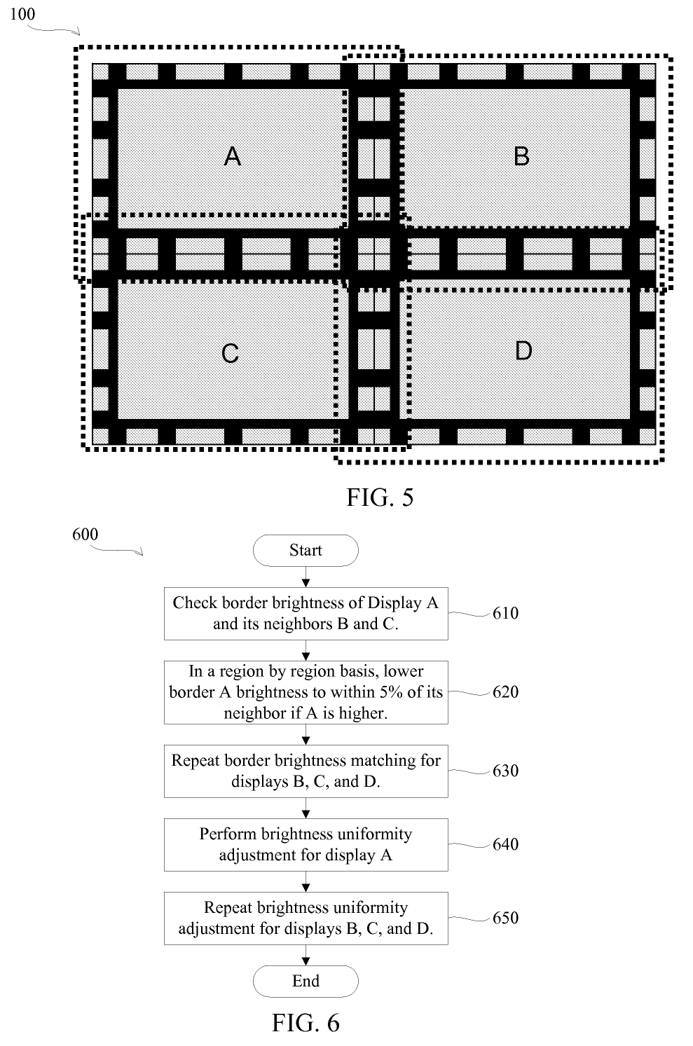

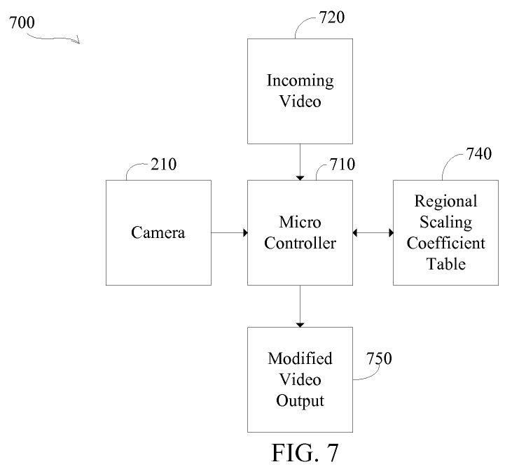

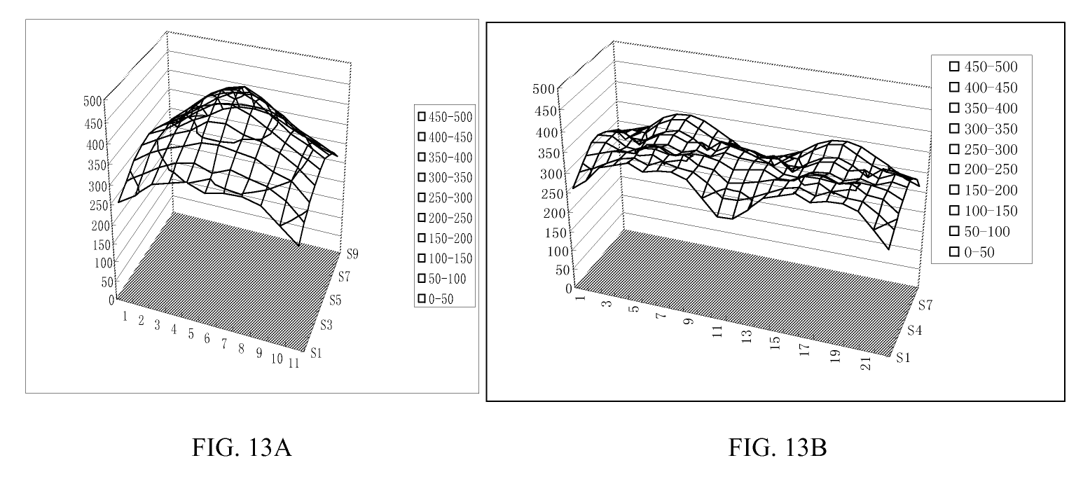

FIG. 6 is a flowchart illustrating a method 600 of adjusting brightness of the display wall 100. First, border brightness of a first display (e.g., display A of FIG. 5) and its neighbors (e.g., displays B and C) are checked (610). In an embodiment, only the borders having adjacent screens are checked, e.g., for screen A, only the right and bottom borders need to be checked. A border can include about 5% of area of a screen in one embodiment. Next, on a region by region basis, border brightness of the first display is lowered (620) to within about 5% of a neighbor's brightness if the brightness of the first display is higher than a neighbor's. In an embodiment, a region includes an entire border facing a neighbor. In another embodiment, a region includes a subdivision of a border (e.g., ⅛ of a border). Next, the border brightness adjustments are repeated (630) for the other screens in the display wall. Brightness uniformity adjustments are then performed (640, 650) for the first screen and other screens in the display wall. The adjustments are done by imaging each the screens and then applying an inverse function to each of the screens. For example, a brightness topography is shown in FIG. 13A. The inverse of this can be applied to a screen, thereby generating a relatively uniform screen brightness. The method 600 then ends. The inverse can be stored in a regional scaling coefficient table 740 (FIG. 7) (one per each screen) generated during manufacture of the display wall 100, during installation of the display 100, and/or after installation (e.g., at intervals, such as power on). In an embodiment, the method 600 can be applied to display walls comprising any number of displays.

FIG. 7 is a block diagram illustrating a circuit 700 for adjusting brightness of the display wall 100. Each module of the display wall 100 can include the circuit 700, which executes the method 600. The circuit 700 comprises a microcontroller (also referred to as a processor) 710 communicatively coupled to the camera 210, the light engine 200, and the regional coefficient table 740. During operation, the microcontroller 710 receives video 720 from a source and brightness data from the camera 210 that images the screen 130. The microcontroller then adjusts border brightness of the video 720 as described above and then adjusts brightness of the entire video using the regional scaling coefficient table 740 as described above, to generate modified video output 750, which is sent to the light engine 200 for projection on the screen 130.

In an embodiment of the invention, the table 740 can also include coefficients for adjusting the border region brightness, i.e., the results of brightness adjustment can be applied to the video output 750, then the screen 130 imaged, then the inverse of the entire screen 130 brightness can be stored in the table 740. Alternatively, the coefficients for adjusting border brightness can be stored in the table 740 and then the inverse for the remaining region of the screen 130 brightness can be stored also in the table 740.

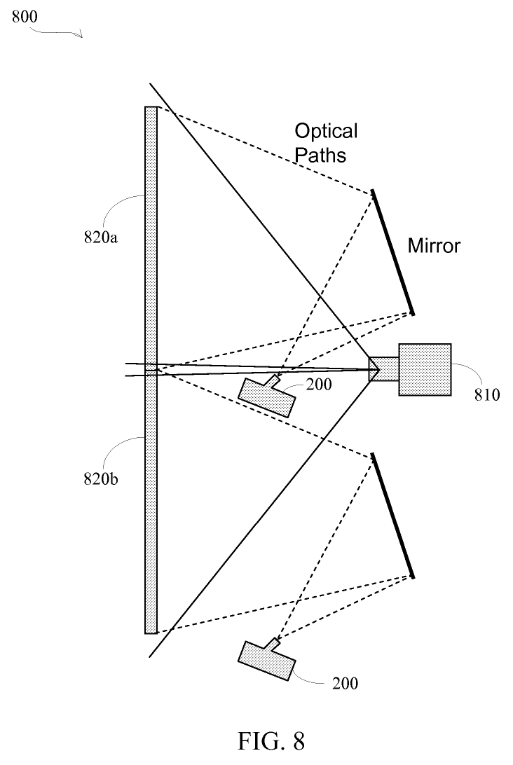

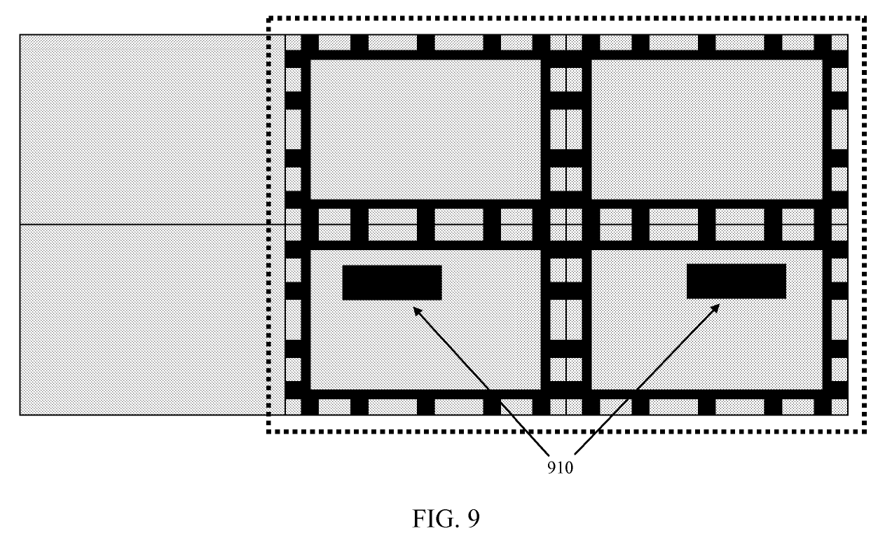

FIG. 8 is a diagram illustrating a display wall 800 according to another embodiment of the invention. The display 800 is substantially similar to the display wall 100 except that a camera 810 images the entire display wall 800 (e.g., 4 screens) instead of a single screen 130. The camera 810 includes a wide angle lens that can be used for the brightness adjustment of 4 displays. This camera 810 can be installed either on a production line, or be added during the construction of a display wall 800. For a single mirror reflection projection design, the light engine 200 is placed near the front of the display 800 and can block some 910 (FIG. 9) of the video information to this camera 810. This camera 810 can clearly see the border areas of the four displays as well as the neighboring displays as shown in FIG. 9 and can still capture the border brightness image need for uniformity adjustment. At display wall construction time, the video output of this camera 810 can be connected through a video distributor to the four displays for brightness uniformity correction. Further, since this camera 810 covers the neighboring displays beyond the four displays, this construction method can be used to assemble very large display walls beyond 2×2.

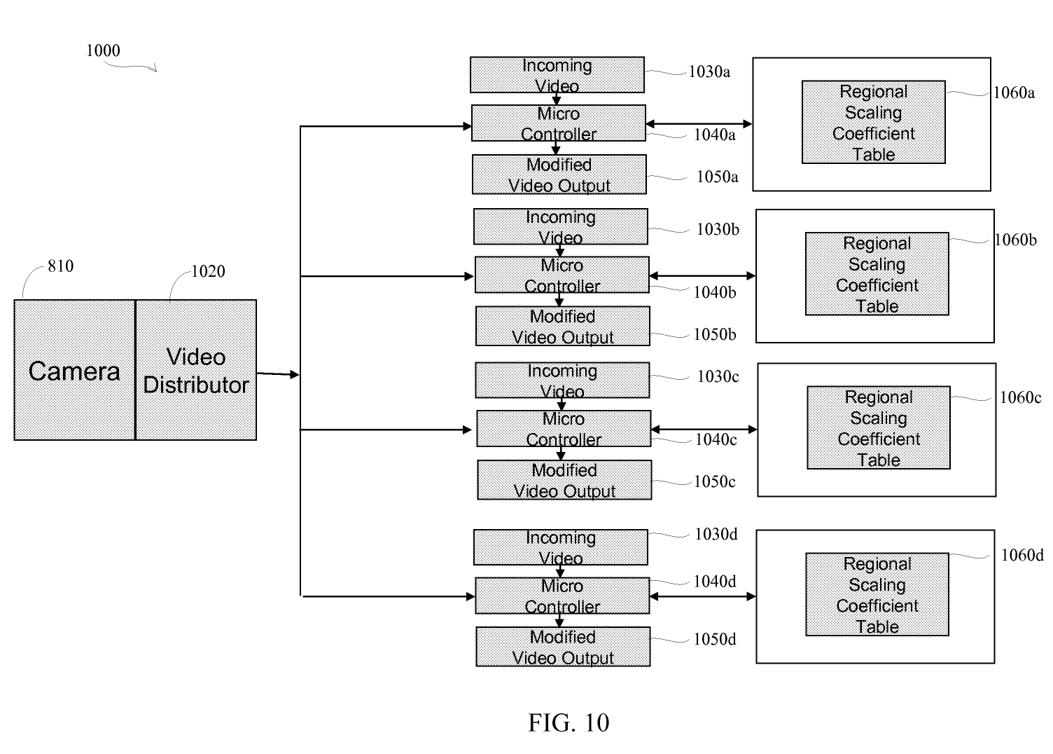

FIG. 10 is a block diagram illustrating a circuit 1000 for adjusting brightness of the display wall 800. The circuit 1000 is similar to the circuit 700 except that a single camera 810 images more than one display of the display wall, thereby necessitating the need for the video distributor 1020, which distributes video data pertaining to the displays to the appropriate controllers 1040.

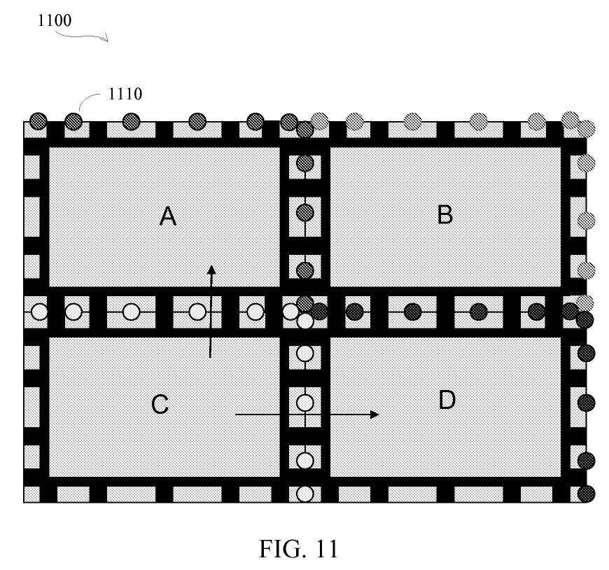

FIG. 11 is a block diagram illustrating a display wall 1100 according to another embodiment of the invention. The display wall 1100 is substantially similar to the display wall 800 except that photodiodes 1110 are used in place of the camera 810. The photodiodes 1110 are placed in between mechanical attachment fixtures of two adjacent displays. These photodiodes 1110 are sensitive to border brightness of both displays, and by turning on one display at a time, can provide border brightness data needed for brightness uniformity matching. Note that since these photodiodes 1110 are used for relative measurement, there is no requirement that their light transfer characteristics must be matched. As shown in FIG. 10, by strategically placing the photo diodes on only two sides, it is sufficient for the brightness correction of a display wall 1100 with many displays in both vertical and horizontal directions. Note that the photodiodes 1110 are not to scale and do not obstruct a significant amount of light reflected onto the displays of the display wall 1100.

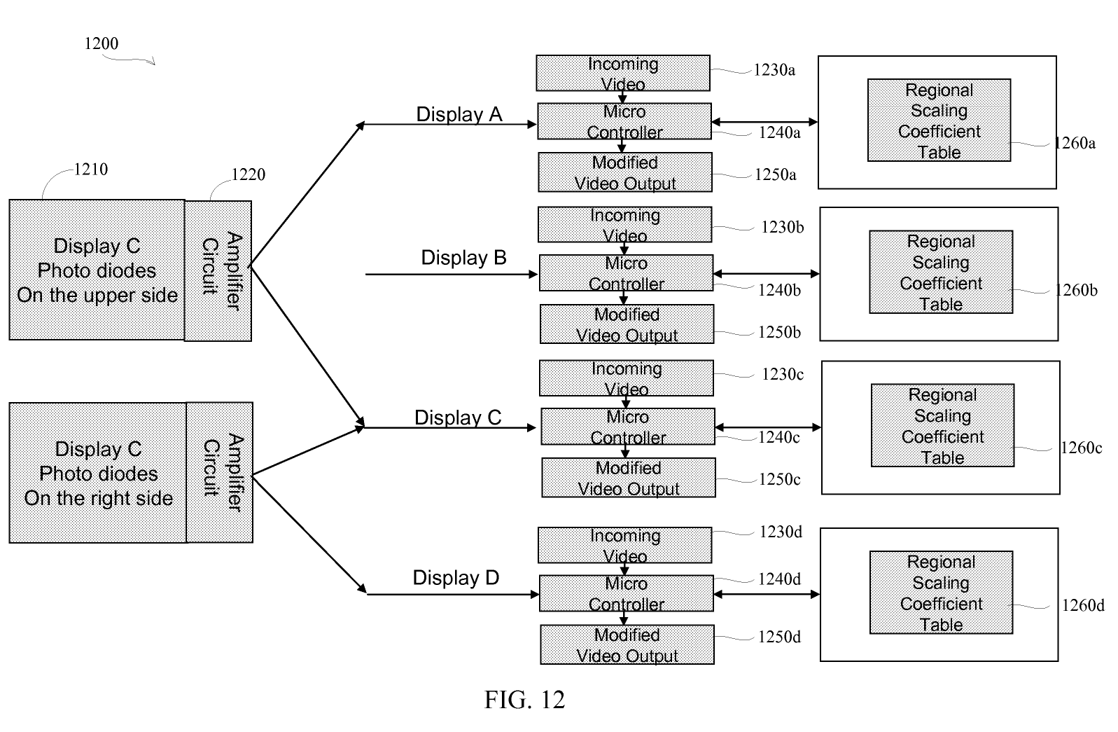

FIG. 12 is a block diagram illustrating a circuit 1200 for adjusting brightness of the display wall 1100. The circuit is substantially similar to the circuit 1000, however, as photodiodes 1110 are used in place of a camera 810, border brightness data is fed via an amplifier 1220 to a microcontroller 1240. After the border brightness is adjusted, the rest of the method 600 can be applied using a regional coefficient table generated either by design, or at the time where individual display module was put together in production.

FIG. 13A and FIG. 13B are graphs showing brightness variation before and after adjustment. Specifically, FIG. 13A shows the brightness distribution data of a single display before uniformity correction. FIG. 13B shows the brightness distribution data of two side-by-side displays after applying uniformity correction for both regional and border areas, e.g., via the method 600.

The foregoing description of the illustrated embodiments of the present invention is by way of example only, and other variations and modifications of the above-described embodiments and methods are possible in light of the foregoing teaching. For example, display walls can comprise more than the 4 displays illustrated. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1 A display wall comprising:
a plurality of display modules, each module having a screen and a light engine capable of projecting an image onto a screen of the module; and
a fixture having ribs and pins; the pins holding the plurality of screens in place via the screens' perimeters.

2. The display wall of claim 1, wherein each module further comprises a camera that images a screen of the module and at least a portion of a screen of an adjacent module.

3. The display wall of claim 2, wherein each pin includes an identification feature visible to the camera.

4. The display wall of claim 3, wherein each module further comprises a processor communicatively coupled to the camera and light engine and is capable of aligning projected images using the identification feature of the pins.

5. The display wall of claim 1, wherein the pins are formed and placed outside of the path of the projected images.

6. The display wall of claim 5, wherein the pins are conical.

7. The display wall of claim 1, wherein each module comprises a mirror coupled to the fixture and wherein the light engine of each module projects an image that reflects off the mirror onto a screen of the module.

8. A display wall comprising:
a plurality of display modules, each module having a screen and a light engine that projects an image onto the screen;
a camera capable of imaging a screen of a display module and at least a portion of a screen of an adjacent module; and
a processor, communicatively coupled to the camera and at least one light engine, capable of adjusting brightness of the at least one light engine such that a projected image from the at least one engine matches brightness of the at least a portion of a screen of an adjacent module within about 5%.

9. The display wall of claim 8, wherein the processor is further capable of adjusting brightness uniformity of the light engine.

10. The display wall of claim 9, further comprising a coefficient table and wherein the processor adjusts the brightness uniformity using the coefficient table.

11. The display wall of claim 8, wherein each module comprises a processor coupled to the camera and the light engine; wherein the display wall further comprises a video distributor capable of distributing video data of the imaged screens among the processors.

12. The display wall of claim 8, wherein the at least a portion of a screen of an adjacent module includes a border area.

13. A method of adjusting brightness in a display wall, comprising:
displaying images on screens of the display wall;
imaging the screens;
determining brightness of border areas of the screens; and
matching brightness of border areas in a screen to within about 5% of border areas of an adjacent screen.

14. The method of claim 13, further comprising adjusting brightness uniformity of each of the images projected onto the screens.

15. The method of claim 14, wherein the adjusting the brightness uniformity uses a coefficient table.

16. The method of claim 13, wherein the imaging the screens uses a single camera and further comprising splitting video data from the camera to processors corresponding to each screen.

17. A system for adjusting brightness in a display wall, comprising:
means for displaying images on screens of the display wall;
means for imaging the screens;
means for determining brightness of border areas of the screens; and
means for matching brightness of border areas in a screen to within about 5% of border areas of an adjacent screen.
